(19) United States
(12) Patent Application Publication
(10) Pub. No.: US 2018/0233890 A1
(43) Pub. Date: Aug. 16, 2018

(54) EXPANDABLE ROOM COMPRISING A PARTITION ELECTRICALLY CONNECTABLE TO A WALL OR A CEILING

(71) Applicant: OWWI, Paris (FR)

(72) Inventor: Grégory VAN DE VELDE, Paris (FR)

(21) Appl. No.: 15/750,429

(22) PCT Filed: Aug. 8, 2016
(86) PCT No.: PCT/EP2016/068903

§ 371 Date: Feb. 5, 2018

(30) Foreign Application Priority Data
Aug. 6, 2015 (FR) 1557595
Nov. 12, 2015 (FR) 1560790

(51) Int. Cl. H02G 3/36; H02G 1/06; H01R 13/73; H01R 25/14; E04B 2/74

(52) U.S. Cl. CPC H02G 3/36; H02G 1/06; H01R 13/73; E04B 2002/7488; H01R 25/142; E04B 2/7401; H01R 25/145

(57) ABSTRACT

An expandable room includes at least one wall and a ceiling delimiting a space, a first electrical connector capable of electrically supplying an item of electrical equipment, and at least one removable partition extending in the space. The expandable room further includes a second electrical connector configured to be electrically connected to the first electrical connector in order to electrically supply an item of electrical equipment. The first electrical connector of the wall is configured to allow an electrical connection with the second electrical connector at a plurality of points of the wall or of the ceiling.

### TECHNICAL FIELD

The disclosure relates to expandable houses and the construction methods of expandable houses.

### BACKGROUND

The personal circumstances of any individual homeowner is intended to evolve over time (single, couple, house sharing, with one or more children, practicing or not telecommuting, occurrence of a disability (requiring specific layout of the dwelling place etc.). Thus, the same house can be likely to evolve. More particularly, it would be desirable that the number of rooms in the house and their size or the type of partitions used to arrange the space can evolve over time.

There are known expandable spaces offering to rent bare surfaces adapted for receiving partitions (in particular in the field of office rent). These expandable spaces have floors or gridiron which are electrically equipped in order to allow the installation and the electrical connection of partitions. The installation of partitions, however, proves to be delicate and requires the intervention of professionals, thus generating significant costs for users. In addition, the installation of a power grid in a gridiron or in a raised floor greatly increases their bulk compared to a traditional floor or ceiling, thereby decreasing the height available for the occupants or the number of floors feasible for the same building.

There are also known houses offering a previously arranged area. These houses have bearing walls, a floor and a ceiling electrically equipped. However, the modification or creation of new power supply and the deletion or addition of new partitions prove to be delicate, heavy to perform, and require the recourse to qualified personnel. Deleting partitions can also reveal a hole in the floor or the ceiling, requiring repairing or rebuilding it entirely.

### SUMMARY

Therefore, the disclosure provides an expandable room, simple and quick to arrange and rearrange and does not require the intervention of qualified people, for a moderate cost.

The disclosure finds in particular application in the field of housing, but can also be implemented for the layout of offices, hotels, youth hostels, shops, or any other space likely to be converted.

For this, the disclosure provides a room comprising:
at least one wall delimiting a space, said wall comprising a lower edge and an upper edge separated by two lateral edges,
a ceiling, said ceiling having a first side, adjacent to the upper edge of the wall and a second side, distant from the first side,
a first electrical connector able to supply power to an electrical equipment, said first connector being fastened on the wall or the ceiling, and
at least one removable partition, extending in the space.

The partition comprises a second electrical connector configured to be electrically connected to the first electrical connector in order to supply power to an electrical equipment, and the first electrical connector is configured to allow an electrical connection with the second electrical connector at several points of the wall between the lateral edges and/or at several points of the ceiling between the first and the second side.

Some preferred but non-limiting features of the room described above are the following, taken individually or in combination:
the first electrical connector comprises a connecting strip extending between the lateral edges of the wall and/or between the first and second side of the ceiling, so that the first connector is configured to allow an electrical connection with the second electrical connector at any point of said connecting strip
the first electrical connector comprises a movable power socket fastened on a pre-wired baseboard of the electrostrip type
the first electrical connector comprises at least three conductive blades forming the connecting strip, said conductive blades extending substantially parallel to each other between the lateral edges of the wall and/or between the first and second side of the ceiling, each conductive blade being connected to a dedicated electrical wire corresponding respectively to the earth, the ground and the phase, and the second electrical connector comprises a power socket having three conductive contacts configured to come into contact with one of the conductive blades, respectively,
the three blades and the three conductive contacts are separated from each other by an insulating material,
the first electrical connector comprises a plurality of discrete power sockets distributed between the lateral edges of the wall,
the room further comprises a floor, adjacent the lower edge of the wall, the second electrical connector being adjacent to the ceiling or the floor of the room,
the room further comprises a floor, adjacent respectively to the lower edge of the wall, the ceiling and/or the floor and/or the wall comprising fastening means of the partition to maintain the partition in position relative to the wall,
the fastening means comprise at least one of the following elements: at least one rail, fastened in the ceiling, the floor and/or the wall and configured to receive a section of the partition, a cylinder, fastened on the partition and configured to adjust a distance between said partition and the ceiling and/or the floor and/or the wall, and/or the snap-fitting members, formed respectively in the ceiling and/or the floor and/or the wall, on the one hand, and on an area facing the section of the second partition, on the other hand,
the partition further comprises an electrical cable extending from the second electrical connector to a third electrical connector likely to supply power to an electrical equipment,
the room further comprises an additional partition, said additional partition comprising an additional electrical connector configured to be connected to the first electrical connector,
the additional electrical connector is configured to be connected directly to the first electrical connector, or indirectly to the first electrical connector through the second electrical connector, and
the room further comprises a circuit breaker connected to the first electrical connector.

According to a second aspect, the disclosure also provides a layout method of an expandable room as described above, comprising the following steps:
fastening the first connector on a wall of the room between the lateral edges of the wall and/or on the ceiling of the room between the first and the second side of the ceiling, said first connector being likely to supply power to an electrical equipment,
fastening a removable partition in the space, and
electrically connecting the second connector on the first connector at a point of the first electrical connector located between the lateral edges of the wall and/or between the first and second side of the ceiling.

Some preferred but not-limiting features of the layout method described above are the following, taken individually or in combination:
the fastening step of the first connector comprises the following substeps:
   forming a parting cut in the wall between the lateral edges or in the ceiling between the first side and the second side, said parting cut being open to the space,
   placing three conductive blades in the parting cut, so that said conductive blades extend substantially parallel to each other between the lateral edges of the wall and/or between the first and second side of the ceiling, and
   electrically connecting each conductive blade to a dedicated electrical wire corresponding respectively to the earth, the ground and the phase, and
the method further comprises a step of laying a cover on the first electrical connector.

### BRIEF DESCRIPTION OF THE DRAWINGS

Other features and advantages of the present disclosure will appear better upon reading the detailed description which follows, and in view of the appended drawings given as non-limiting examples and in which:

FIG. 1 is a partial perspective view of an embodiment of a room comprising a first partition connected to a wall and a second partition likely to be also connected,

FIG. 2 is a perspective view of an embodiment of a first connector which can be used in a room in accordance with the disclosure,

FIG. 3 is a perspective view of a second connector which can be connected to the first connector of FIG. 2,

FIG. 4 is a side view of a fastening example of fastening means of a removable partition which can be used in a room in accordance with the disclosure, and

FIG. 5 is a flowchart illustrating different steps of an embodiment of a layout method of a room in accordance with the disclosure.

### DETAILED DESCRIPTION OF THE DRAWINGS

A room 1 in accordance with the disclosure comprises:
at least one wall 10 delimiting a space 5, said wall 10 comprising a lower edge 11 and an upper edge 12 separated by two lateral edges 13,
a ceiling 4, said ceiling 4 comprising a first side, adjacent to the upper edge of the wall, and a second side, distant from the first side,
a first electrical connector 14 able to supply power to an electrical equipment 2, said first connector 14 being fastened on the wall 10 or on the ceiling 4, and
at least one removable partition 20, extending in the space 5.

Conventionally, the room 1 can comprise several walls 10, each of which can comprise one or more joinery elements, such as a door, a window, an opening, etc., and the ceiling 4 and a floor 3, which extend substantially perpendicular to the wall 10. The ceiling 4 is adjacent to the upper edge 12 of the wall 10, while the floor 3 is adjacent to its lower edge 11. Therefore, the walls 10, the ceiling 4 and the floor 3 delimit together the space 5 receiving the partition 20.

All or part of the walls 10 may bearing walls or comprise simple fixed partitions (in opposition to the removable partitions 20).

The removable partition 20 comprises first face 21 and a second face 22 which are substantially parallel and are separated by a section 23. The removable partition 20 may comprise a framework made of wood or metal, one or more gypsum panel(s), a glass, plastic, vegetated partition, etc.

The removable partition 20 further comprises a second electrical connector 24 configured to be electrically connected to the first electrical connector 14 of the wall 10 in order to supply power to an electrical equipment 2. Furthermore, the first electrical connector 14 of the wall 10 is configured to allow an electrical connection with the second electrical connector 24 at several points of the wall 10 between its lateral edges 13 and/or at several points of the ceiling 4 between the first and the second side of the ceiling 4, depending on where it is fastened.

In this manner, the electrical connection of the removable partition 20 may be performed at several points along the wall 10 or the ceiling 4. A user may thus freely choose the location where he wishes to position the removable partition 20 relative to the wall 10 or to the ceiling 4, without being constrained by a unique and fixed position of the first electrical connector 14 which is fastened on the wall 10 and/or on the ceiling 4.

The first side of the ceiling 4 may extend along the upper edge 11 of the wall 10, the second side of the ceiling 4 then extending away from the upper edge 11 of the wall 10. In this case, when the first connector 14 is fastened on the ceiling 4, said first connector 14 extends between the first and the second side of the ceiling 4, that is to say perpendicular to the upper edge 11 of the wall 10.

Alternatively, the first side of the ceiling 4 may extend in the extension of one of the lateral sides 13 of the wall 10 while the second side of the ceiling 4 may extend in the extension of the other of the lateral sides 13 of the wall 10. In this case, when the first connector 14 is fastened on the ceiling 4, said first connector 14 extends between the first and the second side of the ceiling 4, that is to say substantially parallel to the upper edge 11 of the wall 10.

Of course, other configurations can be considered. Typically, the sides of the ceiling 4 can be determined so that the first connector 14 forms a non-zero and non-perpendicular angle with the upper edge 11 of the wall 10.

In the following, the disclosure will be more particularly described in the case where the first electrical connector 14 is fastened on the wall 10, between its lateral edges 13. This is however not limiting, the disclosure is applicable mutatis mutandis to a room 1 in which the first electrical connector 14 is fastened on the ceiling 4, between its first and second side, as well as in the case where the room 1 comprises both first connectors 14 fastened on the wall 10, between its lateral edges 13 and first connectors 14 fastened on the ceiling 4 between its first and second side. This variant has the advantage of allowing convenient fastening and electrical connection and easy at any point of the room 1, independently of the position of the walls 10.

The first electrical connector 14 may be attached and fastened on an inner face 10a (which corresponds to the face of the wall 10 which extends opposite to the space 5 of the room 1) of the wall 10 and protrude from said face, or alternatively be housed in a parting cut 16 made in the inner face 10a of the wall 10 and which opens to the space 5 in order to reduce the bulk of the first electrical connector 14. For example, the first connector 14 can be housed in a chute 15 which is either fastened to the inner face 10a of the wall 10, or fastened in a parting cut 16 formed in the inner face 10a of the wall 10.

In the case of fastening on the ceiling 4, it will be understood that the first connector 4 may be fastened on the face of the ceiling 4 which extends in the direction of the floor 3 towards the space 5 of the room 1.

In a first embodiment, the first electrical connector 14 is configured to allow the connection of the removable partition 20 continuously along the wall 10, between the two lateral edges 13.

To this end, the first electrical connector 14 may for example comprise a connecting strip extending between the lateral edges 13 of the wall 10.

Typically, the first electrical connector 14 may comprise a movable power socket fastened on a pre-wired baseboard of the electrostrip type, the position of the power socket can be freely modified along the pre-wired baseboard. The second electrical connector 24 may then comprise an additional power socket, configured to be connected to the movable power socket of the first electrical connector 14. Typically the movable power socket and the complementary power socket may be conventional male and female power sockets.

Alternatively, the first electrical connector 14 may comprise at least three conductive blades 17 extending substantially parallel to each other between the lateral edges 13 of the wall 10, each conductive blade 17 is connected to a dedicated electrical wire 18 corresponding to the earth, the ground and the phase. The conductive blades 17 are preferably spaced apart from each other over their entire length, for example by a distance of the order of 0.5 to 2 centimeters. The second electrical connector 24 may then comprise a power socket of complementary shape and dimension including three conductive contacts 25 configured to come into contact with one of the conductive blades 17, respectively, each conductive contact 25 being connected to a dedicated electrical wire corresponding respectively to the earth, the ground and the phase. The power socket may for example include a base 26 connected to an electrical wire 18 in which are formed three notches 27 each housing one of the conductive contacts 25.

Each notch 27 preferably has a slightly greater thickness than the thickness of the conductive blades 17 in order to allow the insertion of the blades into said notches 27 despite the presence of the conductive contacts 25 while ensuring a sufficient surface contact. For example, for blades having a thickness of the order of 3 mm and conductive contacts 25 having a thickness of 0.4 mm, the notches 27 may have a thickness of about 3.5 mm.

The conductive blades 17 can in particular be made of metal, typically of copper.

The electrical wires are fastened on the conductive blades 17 by any means. For example, the electrical wires can be welded on the conductive blades 17 and/or mechanically fastened, for example by insertion into a through-hole formed in said conductive blades 17.

In one embodiment, the conductive blades 17 are separated, over all or part of their length, by an insulating material. For example, wedges 19 made of insulating material which can be placed between the conductive blades 17, or alternatively, a single wedge 19 comprising three straight grooves arranged to receive the blades may be used. The insulating material may comprise wood, a heat-resistant plastic material, a layered material comprising layers of fabric impregnated with a phenolic resin of the Celeron® canvas type, etc.

Similarly, apart from the conductive contacts 25, the power socket of the second electrical connector 24 may be made of an insulating material such as wood, a heat-resistant plastic material, a layered material comprising layers of fabric impregnated with a phenolic resin of the Celeron® type, etc.

For safety issues, the conductive blades 17 may have a predetermined maximum length in order to limit the number of removable walls which may be electrically connected using a second electrical connector 24. For example, the predetermined maximum length may be equal to three meters.

According to a second embodiment, the first electrical connector 14 may comprise a plurality of discrete power sockets distributed between the lateral edges 13 of the wall 10. The second electrical connector 24 then includes a complementary power socket configured to be electrically connected on any one of the power sockets of the first connector 14.

Regardless of the embodiment, the first electrical connector 14 may be connected to a circuit breaker in order to interrupt the electrical current flowing in the first connector 14 in case of incident on the electrical circuit (overload or short circuit for example).

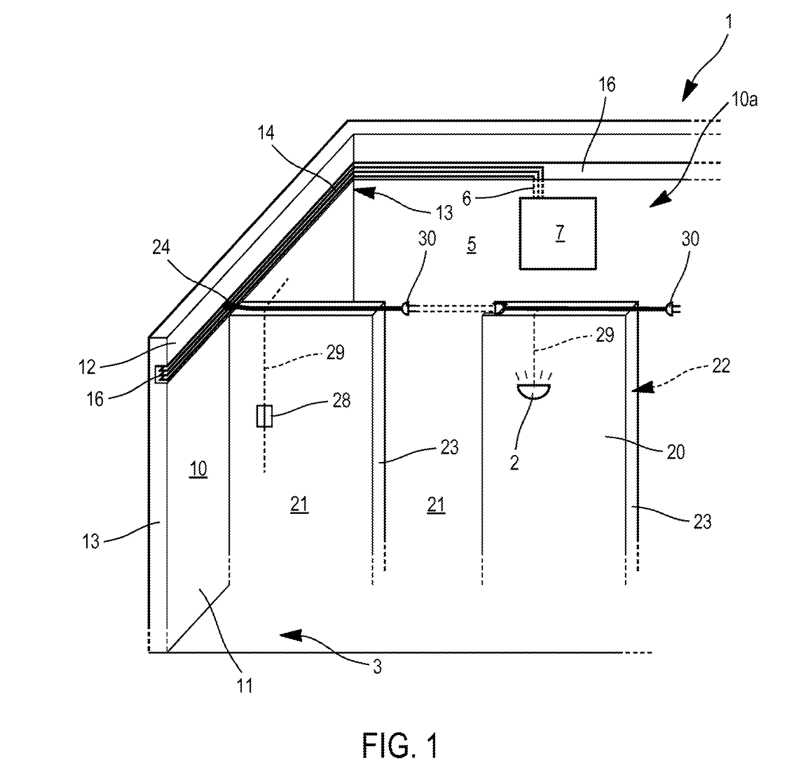

The first connector 14 preferably extends in an area adjacent the upper edge 12 or lower edge 11 of the wall 10. Indeed, such a configuration makes it possible to bypass more easily the possible joinery supported by the wall 10 and/or the removable partition 20. The second connector 24 of the removable partition 20 then extends opposite, either at the upper portion or the lower portion of the section 23 of the partition 20. The second connector 24 may be fastened to one of the faces 21, 22 of the partition 20 or directly on the section 23. Alternatively, the second connector 24 can be housed in a recess formed in the thickness of the partition 20, for example at a corner of the partition 20 (as shown for example in FIG. 1).

To enable the connection of electrical equipment 2 such as a lamp, the partition 20 may further comprise at least a third electrical connector 18, fastened on one of its faces 21, 22 and electrically connected to the second electrical connector 24. For this purpose, the second electrical connector 24 is electrically connected, for example using an electrical cable 29, to the third electrical connector 28. The electrical cable 29 can in particular be housed in the partition 20, for example in a chute formed between its both faces 21, 22.

Alternatively, the electrical cables may simply be connected to the second electrical connector 24 by being accessible to a user in order to allow him to electrically connect a third electrical connector 28 and to fasten it to a desired location on the face 21, 22 of the partition 20.

The room 1 may comprise one or more removable partition(s) 20 which may be electrically connected to one or more wall(s) 10.

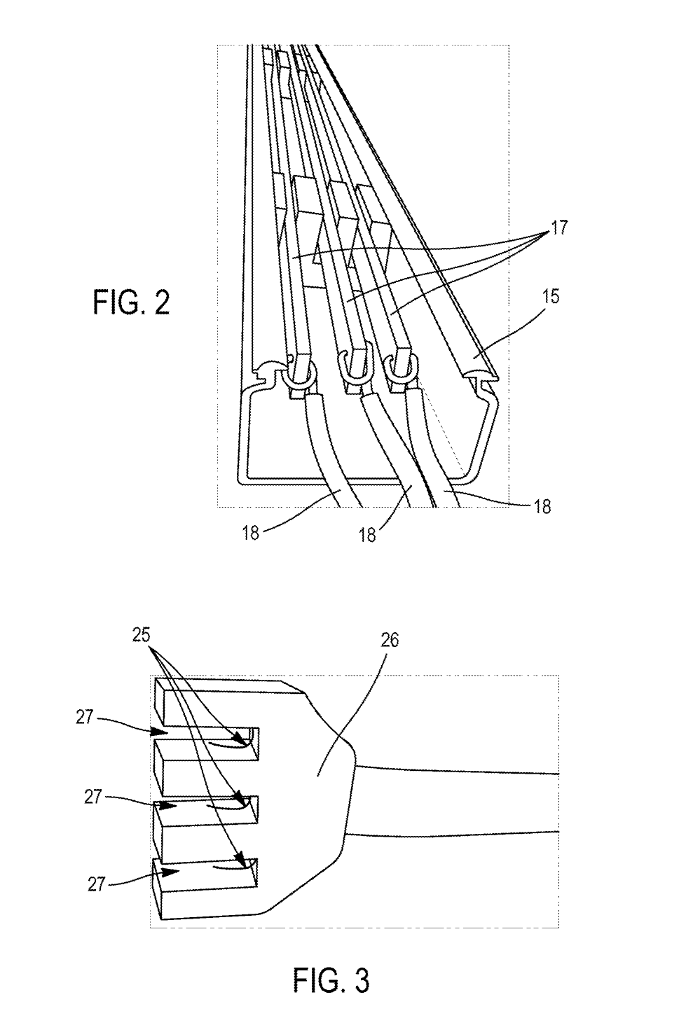

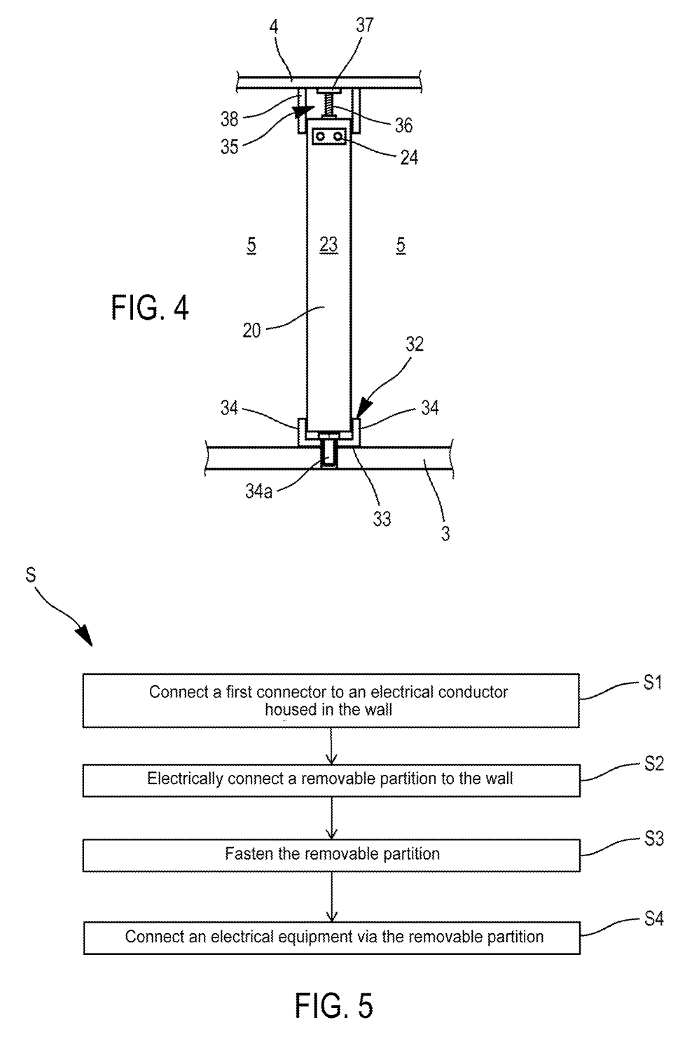

For example, the room 1 can comprise two removable partitions 20 connected directly to the same wall 10. For this, the second connector 24 of each of the partitions 20 is connected in parallel with the first connector 14 of the wall 10. When the first connector 14 comprises three conductive blades 17, as illustrated in FIG. 2, the base 26 of the second connector 24 of each of the partitions 20 may be inserted between the conductive blades 17 in order to allow the transmission of the current.

The room 1 may also comprise two removable partitions 20 connected in series on the same wall 10. In this variant, a first partition 20 is therefore electrically connected via its second connector 24 and to the first connector 14, to the wall 10 of the room 1. The first partition 20 further comprises an additional electrical connector 30 while the second partition 20 comprises a complementary electrical connector 31 of the additional electrical connector 30. It then suffices to connect the complementary electrical connector 31 of the second partition 20 on the additional electrical connector 30 of the first partition 20 to allow the distribution of the electrical current through the second partition 20 to a possible electrical equipment 2 (or a third removable partition 20 and so on). The additional 30 and complementary 31 electrical connectors may be of the male/female power socket type. Alternatively, the additional electrical connector 30 may be substantially identical to the first electrical connector 14 of the wall 10, while the complementary electrical connector 31 may be substantially identical to the second electrical connector 24 of the first partition 20.

It will be understood that the first and the second removable partition 20 may be connected so as to extend in the extension of each other (as illustrated in FIG. 1), or alternatively by forming at an angle different from 180°, typically perpendicular to each other.

Each removable partition 20 may be fastened to the floor 3 and/or to the ceiling 4 and/or to the wall 10 by any conventional fastening means.

For example, the fastening means may comprise a rail 32 fastened on the floor 3, the ceiling 4 and/or the wall 10, configured to receive a portion facing the section 23 of the removable partition 20. The rail 32 may for example comprise a bottom plate 33, and attached and fastened (for example using a self-piercing screw 34a) on the floor 3, the ceiling 4 and/or the wall 10, and a fin 34 which extends from the bottom plate 33. The section 23 of the removable partition 20 can then be inserted and guided in the rail 32 until reaching the desired position relative to the wall 10 then the removable partition 20 can be fastened in this position, for example by screwing or gluing of the fin 34 on the opposite face 21, 22.

Alternatively, the fastening means may comprise snap-fitting members, formed respectively in the ceiling 4 and/or the floor 3 and/or the wall 10 on the one hand and on an area facing the section 23 of the partition 20 on the other hand.

Optionally, the removable partition 20 may comprise a cylinder 35 configured to adjust a distance between the partition 20 and the floor 3, the ceiling 4 or the wall 10. The cylinder 35 thus allows stabilizing the removable partition 20 relative to the ceiling 4, the floor 3 and the wall 10 and if appropriate compensating for irregularities at the contact surface. If necessary, the removable partition 20 may comprise a plurality of cylinders 35s distributed over the section 23. The one or more actuator(s) 35 may be pneumatic, hydraulic or mechanical.

Conventionally, the cylinder 35 comprises a cylinder body 35 and a piston 36, movable in translation in the body. The body of the cylinder 35 may be for example fastened on the partition 20, while the free end of the piston 36 may be linked to a plate 37. The actuation of the cylinder 35 then has the effect of displacing the plate until said plate abuts against the floor 3, the ceiling 4 or the wall 10, depending on the area of the room 1 with which the cylinder 35 cooperates to stabilize the partition 20. If necessary, the area of the room 1 may comprise a housing 38 intended to receive the plate and hold it in position.

Optionally, an anti-skid blade may be further fastened between the removable partition 20 and the floor 3 and/or the ceiling 4 and/or the bearing wall 10, in order to improve the grip and the stability of the removable partition 20.

If necessary, in order to allow an application in the field of home automation, one or more additional first connectic(s) can be integrated into the wall 10 with the first connector 14 while second complementary connectics can be integrated into the partition 20 with the second connector 24 in order to allow the transmission and the exchange of information (internet access, peripheral device control data transfer, telephony data, etc.). For example, the first additional connectic may comprise one or more dedicated metal blades extending along the first connector 14. Preferably, similarly to the first connector 14, the first connectics housed in the wall 10 are configured to allow a connection at several points of the wall 10 between the lateral edges 13.

Alternatively or complementarily, the first connector 14 may be used within the scope of the technology PLC (Power Line Carrier) as a first connectic in order to allow an exchange of data via the electricity network of the room.

An embodiment of a layout method S of a room 1 in accordance with the disclosure will now be described.

Here, the room 1 comprises at least one wall 10, for example a bearing wall 10 comprising at least one electrical conductor 6 connected to an electric board 7. The electrical conductor 6 comprises in particular cables corresponding respectively to the earth, the phase and the neutral.

The room 1 also comprises conventional ceiling 4 and floor 3.

During a first step S1, a first connector 14 is connected to the electrical conductor 6 of the wall 10. For this purpose, a parting cut 16 may be performed in an area adjacent to the upper edge 12 of the wall 10, from a lateral edge of the wall 10 to the other. The parting cut 16 therefore extends here over the entire length of the wall 10, in its upper area.

Alternatively, the parting cut 16 might also extend in a central area of the wall 10 or close to its lower edge 11.

If necessary, a circuit breaker can be fastened on the first connector 14.

In the case of a first connector 14 having three conductive blades 17, as illustrated in FIG. 1, a chute may be fastened in the parting cut 16, for example by gluing, screwing (using self-piercing screws for example) or adhesion. The conductive blades 17 can then be fastened into the chute 15. If necessary, the conductive blades 17 may be separated by an insulating material. Here, wedges 19 made of insulating material including three notches 27 are fastened in the chute 15 at regular intervals, the conductive blades 17 being housed and held in position in said notches 27.

Of course, the chute 15 can be pre-equipped and comprise the wedges 19 and the blades 17 prior to the fastening in the parting cut 16.

The cables 18 can then be fastened on the conductive blades 17 to supply them with electrical current.

In the case of a first connector 14 comprising an electrostrip or a plurality of discrete power sockets distributed between the lateral edges 13 of the wall 10, the electrostrip or the power sockets are placed in the parting cut 16, connected to the electrical conductor 6 of the wall 10 in a conventional manner and fixed in position, for example by gluing, screwing or adhesion.

During a second step S2, a removable partition 20 may be fastened and electrically connected to the wall 10.

The removable partition 20 can be pre-equipped with the second connector 24. Alternatively, the removable partition 20 may be provided as a kit and then assembled by the user according to his needs.

When the wall 10 comprises a first connector 14 including three blades 17, the removable partition 20 is therefore equipped with a complementary second connector 24, namely a base 26 including three conductive contacts 25, as shown in FIG. 3.

Alternatively, the second connector 24 may comprise an individual power socket complementary to the movable power socket of the electrostrip or one of the discrete individual power sockets.

In this embodiment, the first connector 14 being placed in the upper portion of the wall 10, the second connector 24 also extends at the upper portion of the section 23 of the partition 20 in order to facilitate the electrical connection of the partition 20 with the wall 10. The partition 20 may comprise a setback formed in the portion of the section 23 which extends opposite to the wall 10, in order to at least partially house the second connector 24. In this manner, when the partition 20 is electrically connected to the wall 10, the second connector 24 is hidden.

The partition 20 may be pre-equipped with a third electrical connector 28 fastened on one of its faces 21, 22 and electrically linked to its second electrical connector 24.

Alternatively, the partition 20 can be pre-equipped with an additional connector in order to connect an additional partition 20.

According to yet another variant, electrical cables can simply be connected to the second electrical connector 24 by being accessible to a user in order to allow it to electrically connect a third electrical connector 28 and to fasten it to a desired location on the face 21, 22 and/or to connect an additional connector in order to connect an additional partition 20.

In order to connect the partition 20 pre-equipped or assembled as a kit, it is sufficient to connect the second connector 24 of the partition 20 on the first connector 14 of the wall 10. The position of the partition 20 relative to the wall 10 can be selected freely by the user and is not constrained by the position of the first electrical connector 14, the said first electrical connector extending along the wall 10.

During a third step S3, the removable partition 20 may be fastened in position.

Any fastening means may be considered. For example, a rail 32 and optionally a non-skid blade may be fastened on the floor 3 and on the wall 10 in order to receive the section 23 of the partition 20. It then suffices to block the partition 20 by fastening the fin 34 (or the fins 34) of the rail 32 on one of the faces 21, 22 of the partition 20.

If necessary, when the partition 20 comprises a cylinder 35 in order to adjust its position relative to the ceiling 4, to the wall 10 or to the floor 3, the cylinder 35 may be actuated until the plate 37 abuts against this portion of the room 1.

Of course, the second and third steps S2, S3 may be performed simultaneously or in reverse order. In particular, the partition 20 can simultaneously be positioned opposite to the wall 10, in the desired position by the user, electrically connected to the wall 10 using the first and the second connector 24 and fastened in this position using selected fastening means.

The removable partition 20 is then ready for use.

If necessary, an additional partition 20 can be fastened and electrically connected analogously on the wall 10, or fastened on the floor 3 (and/or on the ceiling 4) and on the partition 20 already installed and electrically connected to said partition 20, as explained above. The two partitions 20 are then connected in series.

If necessary, a cover can be fastened on the first connector 14 in order to hide it. The cover can be for example a baseboard or a rigid plate made of plastic material or wood. Preferably, the cover is removable in order to allow the subsequent connection of another connector or the displacement of the movable partition 20 and then the disconnection and reconnection of its second connector 24.

During a fourth step S4, an electrical equipment 2 can be fastened on one of the partitions 20 and electrically connected to a third electrical connector 28 of the concerned partition 20, the third electrical connector 28 is supplied via the first and the second electrical connector 24.

1. A room comprising:
at least one wall delimiting a space and comprising a lower edge and an upper edge separated by two lateral edges,
a ceiling comprising a first side adjacent the upper edge of the wall and a second side distant from the first side, and
a first electrical connector able to supply power to an electrical equipment, said first connector being fastened to the wall or on the ceiling,
wherein the first connector is configured to be electrically connected with a second connector fastened to a removable partition extending into the space to supply power to an electrical equipment,
wherein the first electrical connector is configured to allow an electrical connection with the second electrical connector in several points of the wall between the lateral edges and/or at several points of the ceiling between the first and second side, and
wherein the first electrical connector comprises a connecting strip extending between the lateral edges of the wall and/or at several points of the ceiling between the first and second side, so that the first connector is configured to allow an electrical connection with the second electrical connector at any point of said connecting strip.

2. The room according to claim 1, further comprising a removable partition extending in the space and comprising a second electrical connector configured to be electrically connected to the first electrical connector.

3. The room according to claim 1, wherein the first electrical connector comprises a movable power socket fastened on a pre-wired baseboard of the electrostrip type.

4. The room according to claim 2, wherein:
the first electrical connector comprises at least three conductive blades forming the connecting strip, said conductive blades extending substantially parallel to each other between the lateral edges of the wall and/or at several points of the ceiling between the first and second side, each conductive blade being connected to an dedicated electrical wire corresponding respectively to the earth, the ground and the phase, and
the second electrical connector comprises a power socket including three conductive contacts configured to come into contact with any of the conductive blades, respectively.

5. The room according to claim 4, wherein the three blades and the three conductive contacts are separated from each other by an insulating material.

6. The room according to claim 1, wherein the first electrical connector comprises a plurality of discrete power sockets distributed between the lateral edges of the wall and/or at several points of the ceiling between the first and the second side.

7. The room according to claim 1, further comprising a floor, adjacent to the lower edge of the wall, the second electrical connector being adjacent to the ceiling or to the floor of the room.

8. The room according to claim 1, further comprising a floor, adjacent to the lower edge of the wall, the ceiling and/or the floor and/or the wall comprising fastening means of the partition in order to maintain the partition in position relative to the wall.

9. The room according to claim 8, wherein the fastening means comprise at least one of the following elements:
at least one rail fastened in the ceiling, in the floor and/or in the wall and configured to receive a section of the partition,
a cylinder, fastened to the partition and configured to adjust a distance between said partition and the ceiling and/or the floor and/or the wall,
snap-fitting members, formed respectively in the ceiling and/or the floor and/or the wall on the one hand and on an area facing the section of the partition on the other hand.

10. The room according to claim 1, wherein the partition further comprises an electrical cable extending from the second electrical connector to a third electrical connector likely to supply power to an electrical equipment.

11. The room according to claim 1, further comprising an additional partition, said partition further comprising an additional electrical connector configured to be connected to the first electrical connector.

12. The room according to claim 11, wherein the additional electrical connector is configured to be connected directly to the first electrical connector or indirectly to the first electrical connector by means of the second electrical connector.

13. The room according to claim 1, further comprising a circuit breaker connected to the first electrical connector.

14. A layout method of a room according to claim 1, said room further comprising a removable partition, extending in the space and comprising a second electrical connector configured to be electrically connected to the first electrical connector, the method comprising the following steps:
fastening the first connector on a wall of the room between the lateral edges of the wall and/or on a ceiling of the room between the first and second sides, said first connector being likely to supply power to an electrical equipment,
fastening a removable partition in the space, and
the layout method wherein the method further comprises a connection step of the second electrical connector on the first connector at a point of the first electrical connector located between the lateral edges of the wall and/or a point of the first electrical connector located between the first and the second side of the ceiling.

15. The method according to claim 14, wherein the fastening step of the first connector comprises the following substeps:
forming a parting cut in the wall between the lateral edges and/or between the first and the second side of the ceiling, said parting cut being open to the space,
placing three conductive blades in the parting cut, so that said conductive blades extend substantially parallel to each other between the lateral edges of the wall and/or between the first and second side of the ceiling, and
electrically connecting each conductive blade to a dedicated electrical wire respectively corresponding to the earth, the ground and the phase.

16. The method according to claim 14, further comprising a step of putting a cover on the first electrical connector.

17. A removable partition configured to extend into the space of a room according to claim 1, said room comprising a first electrical connector likely to supply power to an electrical equipment, said first connector being fastened on a wall or a ceiling of the room,
wherein the first electrical connector comprises a connecting strip extending between the lateral edges of the wall and/or between the first and the second side of the ceiling so that the first electrical connector is configured to allow an electrical connection at several points of the wall between the lateral edges and/or at several points of the ceiling between the first and the second side,
the partition comprising a second electrical connector configured to be electrically connected to the first electrical connector in order to supply power to an electrical equipment, so that the removable partition is configured to be electrically connected with the first connector at any point of the connecting strip.
